(19) United States
(12) Patent Application Publication
(10) Pub. No.: US 2015/0251590 A1
(43) Pub. Date: Sep. 10, 2015

(54) HANDLE WITH LIGHTING

(71) Applicant: OECHSLER AKTIENGESELLSCHAFT, Ansbach (DE)

(72) Inventors: Winfried SCHMIDT, Wassertrudingen (DE); Matthias WEISSKOPF, Bechhofen (DE); Robert MEIERLE, Stopfenheim (DE)

(73) Assignee: OECHSLER AKTIENGESELLSCHAFT, Ansbach (DE)

(21) Appl. No.: 14/642,046

(22) Filed: Mar. 9, 2015

(30) Foreign Application Priority Data
Mar. 10, 2014 (DE) 10 2014 003 452.6

(51) Int. Cl. B60Q 1/26

(52) U.S. Cl. CPC B60Q 1/2669; B60Q 2400/50

(57) ABSTRACT

A handle with haptically high-quality surfaces has decorative and functional symbols above, in or beneath a disc, with a corona-like emission being brought about by the end region of a light-conducting hollow cylinder along the peripheral region of said disc, continuously or intermittently circumferentially, which hollow cylinder is fed from a lighting distribution board parallel to the disc. At the same time, the hollow cylinder radiates centripetally into the peripheral region in so far as it comprises light-conducting material. Apertures representing symbols in the disc can contain fibre optic conductors, which are likewise connected to the lighting distribution board.

DE 10 2012 00 073 A1 discloses a handle for effecting switching operations depending on the movement of a fingertip over the surface of a disc consisting of injection-moulded ceramic, beneath which electrode sectors, which are delimited with respect to one another, are arranged and are connected to a sensor evaluation circuit, namely in respect of the local sequence of changes in capacitance brought about manually in this way. In particular for user guidance, dedicated regions of the dielectric disc can be transluminated by means of local emissions from a fibre optic conductor into which a positioned light source radiates and which can also protrude through apertures in the disc. The disc is surrounded by a bead-shaped frame which engages in a support structure axially parallel towards the rear, on the side remote from the visible side. Said supporting structure can be surrounded by a coaxial hollow-cylindrical adjusting ring which is likewise covered by that frame on the end side and thus the visible side.

Such a moveable or rigidly mounted handle has proven successful from a technical point of view and also in respect of its excellent haptics in the case of complex manual control operations, in particular in the automotive sector, for example as actuating insert in a visually and haptically high-quality operating unit.

The present invention is based on the technical problem of developing and optimizing the user friendliness of a comparable handle by dedicated lighting effects, taking into consideration stringent demands placed on haptics and optics, in particular taking into consideration easily practicable and space-saving mounting possibilities for the lighting measures.

This object is achieved according to the invention by the essential features specified in the main claim. According to said claim, the disc is positioned within an approximately axially parallel light-conducting structure having an interrupted or circumferential wall in the manner of a segmented or solid-wall hollow cylinder. Said hollow cylinder radiates light down onto at least the peripheral region of the disc, inter alia centripetally, in corona-like fashion at a flat angle on the visible side, and possibly additionally centripetally into the, at least in its peripheral region, light-conducting and light-scattering disc. Light is fed to the light-conducting hollow cylinder via a plate-shaped lighting distribution board, which is held beneath the disc, approximately parallel thereto. Preferably, the hollow cylinder is also designed for mechanically holding the lighting distribution board in the interior of the frame enclosing the disc. In this case, this handle with its haptically high-quality surfaces has decorative and/or functional symbols above, in or beneath the disc, with the corona-like emission taking place from the end region of the light-conducting structure, referred to here for ease as hollow cylinder, along the peripheral region of said disc continuously or intermittently circumferentially. Apertures in the disc representing symbols in cross section can contain fibre optic conductors, which are likewise connected to the lighting distribution board.

Within the context of the present invention, the disc does not need to be bordered in circular fashion and also does not need to be flat; instead, it can also be a three dimensionally worked workpiece or better still an injection-moulded part, possibly with its cavities or apertures corresponding to the symbols to be represented. These cavities or apertures can be filled with light-conducting materials using single-component or multi-component injection moulding. The surface of the disc can also be structured such that it provides a limited circumference on tactile information symbols and/or structures as operating aid.

All of these variants of the solution according to the invention are characterized by desirable illumination of the information and/or decorative symbols positioned above, in or beneath the disc. The symbols are transluminated or illuminated by a ring-shaped emitter in the form of the upper front end of the hollow cylinder surrounding the disc, which produces an optionally homogeneous or intermittent corona effect within and/or above a ring-shaped transition region from the peripheral region of the disc to the frame.

In the interests of a haptically high-quality surface, the disc preferably consists of moulded or injection-moulded ceramic or glass. The disc can be an information carrier in so far as symbols are engraved mechanically or thermally directly into the surface of said disc on the visible side, possibly also into the rear surface which is remote from the visible side, or into an otherwise light-impermeable lamination on the or beneath a translucent or transparent disc. However, this disc can also be printed on the visible side or on the rear side with information or decorative symbols. In addition, instead of the disc directly, a film can be the substrate for such symbols, which film is arranged on this disc in front of or behind said disc on the viewer's side. A plastic disc can also be laminated with a haptically high-quality film on its surface on the viewer's side, which film is then expediently at the same time the symbol substrate. Positioned behind, i.e. beneath, the disc, a symbol film can be part of a more complex, in particular multi-ply functional layer, which also contains compensating layers and adhesive layers and possibly a scattering film.

Specifically as a development of the capacitive touch-sensitive switch described at the outset, provision can advantageously also be made for the disc as injection-moulded-ceramic dielectric to be inserted above an electrode arrangement behind the disc. The surface of said disc is expediently shaped for operator guidance with a tactile topography corresponding to the electrode sectors. The electrodes are arranged above an evaluation circuit, beneath which the lighting distribution board extends. Light-emitting diodes for feeding in light can be fed from this circuit.

Additional modifications, developments and alternatives within the scope of the solution according to the invention can be gleaned from the dependent claims and, taking into consideration the advantages thereof as well, from the description below of preferred exemplary embodiments sketched in a manner abstracted to the functional essentials, approximately true to scale, of the illuminated handle according to the invention. The drawing shows basic illustrations with a broken-away axial longitudinal section in the handle of a disc, where:

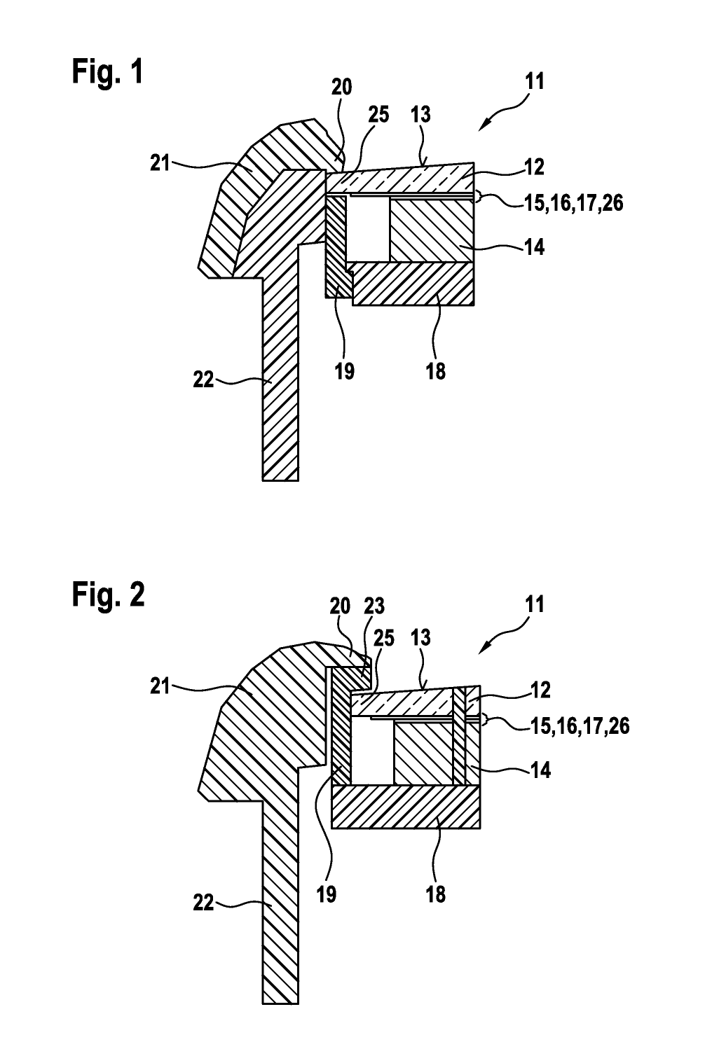

FIG. 1 shows peripheral transradiation,

FIG. 2 shows peripheral incoming radiation,

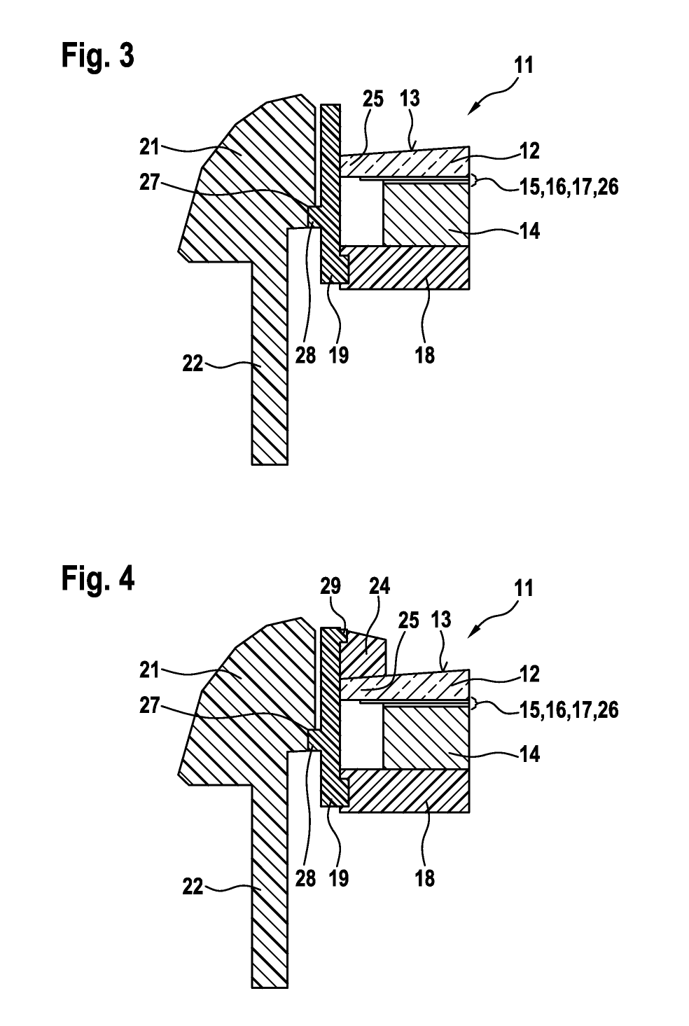

FIG. 3 shows corona irradiation along the peripheral region of the disc, and

FIG. 4 shows corona irradiation through a cover of the peripheral region.

In the case of the handles 11 sketched in the drawing and provided as sensor switches with capacitive spatial resolution, a circuit 14 is housed beneath an electrically insulating, possibly regionally transparent or translucent or light-conducting disc 12 consisting of injection-moulded or moulded material. This electrically insulating disc 12 which is transparent or is translucent at least along its circumferential peripheral region 25, having a haptically high-quality surface 13, preferably consists of clear-ceramic-cured injection-mouldable plastic, such as glass ceramic or glass, or is laminated therewith.

The tactile and therefore haptically high-quality surface 13 of the disc 12 on the visible side can be continuously planar, as well as concave in the form of a key or convex in the form of a ball. For tactile operator guidance, said disc can also be structured, for example with local ribs and with mutually delimited, mutually adjacent convex or concave regions. Likewise for user guidance, information and/or decorative symbols can be applied to the surface 13 on the visible side and/or to the surface of the disc 12 which is opposite that on the visible side, for example printed, engraved or worked from a light-impermeable lamination thereon. Apertures can be introduced or formed in the disc 12 (cf. FIG. 2), wherein material which is light-conducting after curing is injected or cast into said apertures, or fibre optic conductors produced and provided separately are introduced into said apertures. The disc 12 can also be provided with at least one symbol film over the entire area or regionally, which symbol film for its part has a haptically sympathetic surface, in the case of the arrangement on the disc surface 13.

In the sketched example of the use of the handle 11 as sensor switch, the evaluation circuit 14 thereof is connected to electrodes 15, which are arranged above the circuit 14 in a common plane, distanced with respect to one another as sectorially and otherwise geometrically delimited areas. Preferably, as sketched, a complex, multi-ply functional layer 16 having symbol film, compensating and adhesive layers 26 and possibly a scattering film is beneath the disc 12. Thanks to its adhesive layer, the functional layer 16 can also perform the task of a splinter protection film which otherwise needs to be applied separately and which prevents disc splinters from springing off on breakage of a disc 12 consisting of a brittle material such as ceramic or glass as reversed adhesive bonding on the rear. This makes a protective cover which otherwise needs to be taken into consideration superfluous on the disc surface 13.

At least one light source (not illustrated in the basic sketches) such as, in particular, at least one light-emitting semiconductor diode (LED) radiates into at least one approximately plate-shaped lighting distribution board 18, which is preferably positioned parallel to the disc 12 and possibly directly behind the circuit 14 and via said lighting distribution board into the structure which guides light approximately axially parallel and which surrounds the peripheral region 25 on the end side intermittently or continuously and is referred to as fibre optic conductor hollow cylinder 19 for simplicity's sake in the exemplary embodiment sketched.

If this hollow cylinder 19 has a plurality of axially parallel sectors, separate sections of the lighting distribution board 18 can be assigned to said sectors in order to emit light from delimited circumferential regions of the hollow cylinder 19 in different colours or in time-controlled fashion, for example by means of individually assigned LEDs. Axially parallel air gaps between the fibre optic conductor and hollow cylinder sections prevent radiation from spilling over from adjacent sectors.

The hollow cylinder 19 or its sectors are positioned, without any gaps, on the rim of the lighting distribution board 18 or the individual sections thereof on the side remote from the visible side (FIG. 2) or are positioned centrifugally adjacent thereto (cf. FIG. 1, 3 or 4). In this case, as indicated, latching structures, for example local end engagements, can be provided for these mechanical connections. In particular in the case of sectorial subdivision, provision can also be made for in each case one of the light-conducting hollow cylinder sectors, together with its lighting distribution board sector, to be manufactured in one part using plastic injection moulding and for these sectors then to be mounted in a frame 21. In FIG. 2, the fact that, from the lighting distribution board 18, branches or (as sketched) attachments can also pass through the disc 12 with symbol-representing cross sections axially parallel in order to emit correspondingly geometrically delimited decorative or information symbols out of the plane of the disc surface 13 is taken into consideration.

In the embodiment shown in FIG. 1, an axially parallel, in this case hollow-cylindrical substrate 22 consisting of plastic is integrally formed or fastened cohesively, or in a force-fitting or form-fitting manner on the reverse to a frame 21 surrounding the rim 25 of the disc 12. In the embodiments shown in the other figures of the present drawing, the frame 21 together with the substrate 22 adjoining behind said frame, which substrate is used for mounting the frame 21, is instead formed integrally, in particular using plastic injection moulding. A bead 20 which protrudes centripetally around the rim 25 of the disc 12 can be injection-moulded in one part with the frame 21 or can be in the form of a ring-shaped end support 24 to be mounted separately over the disc rim 25 (FIG. 4). In particular the frame 21 positioned on the visible side and its substrate 22 arranged axially behind said frame are produced from different materials in an advantageous manner, possibly using multi-component injection moulding, for reasons of cost and fitting, wherein owing to the haptics only the surface of the frame 21 consists of “surface-precious” namely haptically high-quality but brittle material such as, in particular, moulded ceramic, injection-moulded ceramic, glass ceramic, cast glass or glass. The circumferential frame 21 can also consist of plastic, however, especially in one part with the substrate 22, and can be laminated with a haptically precious surface. The lighting distribution board 18 is suspended in a form-fitting manner, cohesively or, as sketched in FIG. 1, in a force-fitting manner on the inner lateral surface of the frame substrate 22 via the hollow cylinder 19.

The disc 12 is in any case transparent, at least translucent, in its peripheral region 25 which is positioned at the front end, facing the viewer, of the light-conducting hollow cylinder 19 which results in a slightly shadowed and thus corona-like transradiation on the viewer's side owing to the bead 20 when the peripheral region 25 is positioned on the hollow cylinder 19 shown in FIG. 1. In so far as the disc 12 conducts light, centripetal radiation into the peripheral region 25 of said disc takes place starting from the hollow cylinder 19 as well, for example in order to backlight symbols provided on or in the disc 12 or in order to sweep over symbols arranged in or behind the disc 12.

As shown in FIG. 2, the bead 20 no longer bears directly against the surface 13 of the disc 12 on the visible side circumferentially along the peripheral region 25, but on the front end, on the viewer's side, of the hollow cylinder 19, with a centripetally collar-shaped peripheral bent-back portion 23 axially interposed, which hollow cylinder in turn is connected, axially with respect thereto, to the lighting distribution board 18 in light-conducting fashion. With this bent-back portion 23, the lighting distribution board 18 is positioned beneath the frame bead 20. It can be fastened cohesively there, but can also be held by the frame 21 cohesively or in a force-fitting or form-fitting manner. In addition to the incoming radiation from the hollow cylinder 19 into the end of the disc peripheral region 25, that bent-back portion 23 results in centripetal circumferential irradiation of the disc peripheral region 25 on the disc surface 13 which causes scattered light on, in or beneath the provided symbols, again with a desirable corona effect, now owing to very high luminance of the light exit along the hollow cylinder bent-back portion 23 which is circumferential above the disc peripheral region 25. Beneath this hollow cylinder bent-back portion 23, the hollow cylinder 19 again surrounds the peripheral region 25 of the disc 12.

In contrast, the light-emitting hollow cylinder 19 which always encloses the disc 12 ends within the frame 21 and axially parallel above the peripheral region 25 of the disc 12, as shown in FIG. 3 and FIG. 4, which likewise results in a certain corona effect for the viewer of the disc surface 13 owing to the direct emission surrounding said disc surface. In addition, centripetal light radiation from the hollow cylinder 19 into the peripheral region 25 of the disc 12 positioned in said hollow cylinder again takes place if said peripheral region conducts light. Again the disc 12 can be positioned above the housing or the sprue of the circuit 14 on the lighting distribution board 18, but this is fastened on the interior of the frame 21 via the hollow cylinder 19.

As shown in FIG. 4, a ring-shaped end support 24 is provided instead of the bead 20 for laminating the disc peripheral region 25 on the visible side, which end support is enclosed axially on the disc 12 between its peripheral region 25 and a centripetal tapering 29 in the hollow cylinder 19. In this case, a corona light emission which is less pregnant, however, takes place from beneath the end support 24, in addition to the centripetal radiation into the disc 12.

A preassembled structural unit comprising the lighting distribution board 18, possibly together with a circuit 14 resting thereon with electrodes 15 positioned above said circuit, with a multi-ply complex functional layer 16 comprising adhesive and compensating layers 26 together with functional and scattering films 17 and a disc 12 positioned thereabove being inserted, assembled and enclosed by means of the hollow cylinder 19, can be pushed coaxially into the frame 21 from the rear, i.e. in the opposite direction to the viewing direction, until, for example, it hits an axial stop 27, which may also be the bead 20.

The handle 11 therefore has, in accordance with the invention, functional and/or decorative symbols above, in or beneath the disc 12 with a haptically high-quality surface 13 or lamination. A centripetal, corona-like emission which is intermittently or continuously circumferential takes place along the disc peripheral region 25 above, in or beneath said region from the end region of the approximately axially parallel light-conducting structure with an intermittent or circumferential wall in the manner of a segmented or solid-wall hollow cylinder 19. For this purpose, the light-conducting wall of the hollow cylinder 19 is fed from a lighting distribution board 18 held parallel to the disc 12. Light-conducting plastic can be injected or cast into symbol-representing apertures in the disc 12 or a prefabricated fibre optic conductor structure can be used, which is likewise connected, in such a way as to conduct light, to the lighting distribution board 18. Such a handle 11 is preferably inserted as a preassembled unit rearwards into a frame 21 consisting of a haptically sympathetic material such as, in particular, injection-moulded ceramic or cast glass.

### LIST OF REFERENCE SYMBOLS

11 Handle

12 Disc (in 11)

13 Surface (of 12)

14 Circuit (behind 12, above 18)

15 Electrodes (behind 12, on 14)

16 Multi-ply functional layer (between 12 and 14/15)

17 Scattering film (in 16)

18 Lighting distribution board (behind 14)

19 Hollow cylinder (between 18 and 12)

20 Bead (on 21, above 25)

21 Frame (possibly with 20)

22 Substrate (for 21)

23 Bent-back portion (on 19)

24 End support (within 19 on 25)

25 Peripheral region (of 12/13)

26 Film, compensating and adhesive layers (of 16)

27 Stop (on 21, for 28)

28 Projection (on 19, towards 27)

29 Tapering (in 19, for 24)

1. Handle comprising:
a lighting distribution board;
a disc bearing symbols; and
an approximately axially parallel light-conducting structure which extends between the lighting distribution board and a peripheral region of the disc bearing symbols, said light-conducting structure having a discontinuous or circumferential wall in the manner of a segmented or solid-wall hollow cylinder, which irradiates or transluminates at least the peripheral region.

2. Handle according to claim 1, comprising a multi-ply functional layer positioned behind the disc and having compensating and adhesive layers and at least one film bearing symbols.

3. Handle according to claim 1, wherein a light-scattering structure, in the form of a scattering film, is arranged in front of the symbols or between incoming light radiation and the lighting distribution board, on the visible side.

4. Handle according to claim 1, wherein the hollow cylinder is arranged in light-conducting fashion on the lighting distribution board in the peripheral region thereof.

5. Handle according to claim 4, wherein the lighting distribution board and the wall of the hollow cylinder are divided into individually irradiatable or emitting sectors.

6. Handle according to claim 1, wherein a preassembled unit comprising the disc with the multi-ply functional layer positioned behind said disc, hollow cylinder and lighting distribution board is inserted into a frame on the side remote from the visible side.

7. Handle according to claim 1, wherein a bent-back portion which protrudes centripetally from the hollow cylinder protrudes beyond the peripheral region of the disc.

8. Handle according to claim 1, wherein the hollow cylinder, passing through between the frame and the disc, protrudes beyond said frame and disc axially.

9. Handle according to claim 8, wherein an end support which is circumferential in the form of a ring is arranged on the rim of the disc beneath a centripetal tapering of the hollow cylinder.

10. Handle according to claim 1, wherein a disc consisting of injection-moulded clear ceramic or glass ceramic or consisting of plastic with a laminated-on film, is arranged within a frame consisting of injection-moulded ceramic, and in that symbols connected to the lighting distribution board are arranged in apertures in the disc.
